(19) United States
(12) Patent Application Publication
(10) Pub. No.: US 2024/0396268 A1
(43) Pub. Date: Nov. 28, 2024

(54) ELECTRICAL SHIELDING FOR WAFER ASSEMBLY OF ELECTRICAL CONNECTOR ASSEMBLY

(71) Applicant: TE Connectivity Solutions GmbH, Schaffhausen (CH)

(72) Inventors: Michael Streckewald, Harrisburg, PA (US); Julia Anne Lachman, York, PA (US); Wei Peng, Middletown, PA (US)

(21) Appl. No.: 18/646,061

(22) Filed: Apr. 25, 2024

Related U.S. Application Data
(60) Provisional application No. 63/504,083, filed on May 24, 2023.

(51) Int. Cl. H01R 13/6585; H01R 13/6592

(52) U.S. Cl. CPC H01R 13/6585; H01R 13/6592

(57) ABSTRACT

A wafer assembly includes a leadframe with signal contacts and cables with signal conductors arranged as a signal pair terminated to the corresponding signal contacts at a cable termination region. The wafer assembly includes a wafer body holding the signal contacts. A ground frame is attached to the wafer body to provide electrical shielding for the leadframe. The wafer assembly includes shield bridges extending across the space between the cable shields and the ground frame to provide shielding for the signal pairs and the terminating ends of the corresponding signal contacts. The shield bridges are formed in place in the cable termination region to electrically connect the ground frame and the cable shields.

### CROSS REFERENCE TO RELATED APPLICATIONS

This application claims benefit to U.S. Provisional Application No. 63/504,083, filed 24 May 2023, titled “ELECTRICAL SHIELDING FOR WAFER ASSEMBLY OF ELECTRICAL CONNECTOR ASSEMBLY”, the subject matter of which is herein incorporated by reference in its entirety.

### BACKGROUND OF THE INVENTION

The subject matter herein relates generally to electrical connectors for a communication system.

Communication systems use electrical connectors to electrically connect various components to allow data communication between the components. For example, electrical connectors may be directly mated together. The electrical connectors typically include a plug connector and a receptacle connector. The connectors may be cable connectors having high speed differential cables terminated to the signal conductors of the connectors. The signal conductors of the two electrical connectors transition between the two connectors. For high-speed connectors, shielding is required, adding to the complexity of the connector designs. However, as data rates increase, conventional shielding is insufficient. For example, at interfaces between the cables and the signal conductors of the connectors signal integrity problems are common.

A need remains for a reliable electrical connector having sufficient electrical shielding for high speed applications.

### BRIEF DESCRIPTION OF THE INVENTION

In one embodiment, a wafer assembly for an electrical connector is provided. The wafer assembly includes a leadframe that has signal contacts extending between mating ends and terminating ends. The signal contacts have main bodies between the mating ends and the terminating ends. The wafer assembly includes cables rearward of the leadframe. Each cable includes first and second signal conductors arranged as a signal pair. The first and second signal conductors are terminated to the terminating ends of the corresponding signal contacts at a cable termination region of the wafer assembly. Each cable includes a cable shield surrounding the conductors to provide shielding for the signal pair and is separated from the conductors by a dielectric insulator. The wafer assembly includes a wafer body holding the main bodies of the signal contacts. The mating ends of the signal contacts extend forward of the wafer body and the terminating ends of the signal contacts extend rearward of the wafer body. The wafer assembly includes a ground frame attached to the wafer body to provide electrical shielding for the leadframe. The wafer assembly includes shield bridges extending across the space between the cable shields and the ground frame to provide shielding for the signal pairs and the terminating ends of the corresponding signal contacts. The shield bridges are formed in place in the cable termination region to electrically connect the ground frame and the cable shields.

In another embodiment, a wafer assembly for an electrical connector is provided. The wafer assembly includes a leadframe that has signal contacts extending between mating ends and terminating ends. The signal contacts have main bodies between the mating ends and the terminating ends. The wafer assembly includes cables rearward of the leadframe. Each cable includes first and second signal conductors arranged as a signal pair. The first and second signal conductors are terminated to the terminating ends of the corresponding signal contacts at a cable termination region of the wafer assembly. Each cable includes a cable shield surrounding the conductors to provide shielding for the signal pair and is separated from the conductors by a dielectric insulator. The wafer assembly includes a wafer body holding the main bodies of the signal contacts. The wafer body has a front, a rear, a first side between the front and the rear, and a second side between the front and the rear. The cables are located rearward of the rear of the wafer body. The wafer body supports the main bodies of the signal contacts. The mating ends extend forward of the front of the wafer body. The terminating ends extend rearward of the rear of the wafer body. The wafer assembly includes a first ground frame attached to the first side of the wafer body to provide electrical shielding for the leadframe. The first ground frame includes first ground shields providing shielding for the mating ends of the corresponding signal contacts. The first ground frame is spaced apart from the cable shields. The wafer assembly includes a second ground frame attached to the second side of the wafer body to provide electrical shielding for the leadframe. The second ground frame is spaced apart from the cable shields. The wafer assembly includes shield bridges extending across the space between the cable shields and the first and second ground frames to provide shielding for the signal pairs and the terminating ends of the corresponding signal contacts. The shield bridges are formed in place in the cable termination region. The shield bridges conform to and surround the cable shields at the ends of the corresponding cables. The shield bridges are electrically connected to the first and second ground frames to electrically connect the first and second ground frames and the cable shields.

In a further embodiment, an electrical connector assembly is provided and includes a housing having a mating interface configured to be mated with a mating electrical connector assembly. The housing has a cavity. The electrical connector assembly includes wafer assemblies received in the cavity and coupled to the housing. The wafer assemblies are arranged in a wafer stack. Each wafer assembly includes a leadframe, a wafer body holding the leadframe, cables coupled to the leadframe at a cable termination region, a ground frame coupled to the wafer body to provide electrical shielding for the leadframe, and shield bridges extending across the space between the cable shields and the ground frame to provide shielding in the cable termination region. The shield bridges are formed in place in the cable termination region to electrically connect the ground frame and the cable shields.

### BRIEF DESCRIPTION OF THE DRAWINGS

FIG. 1 illustrates a communication system in accordance with an exemplary embodiment.

FIG. 2 is a front perspective, partially exploded view of the first electrical connector assembly in accordance with an exemplary embodiment showing the mating interface.

FIG. 3 is a perspective view of the wafer assembly in accordance with an exemplary embodiment.

FIG. 4 is a perspective view of a portion of the wafer assembly in accordance with an exemplary embodiment.

FIG. 5 is a perspective view of a portion of the wafer assembly in accordance with an exemplary embodiment during another stage of assembly.

FIG. 6 is a perspective view of a portion of the wafer assembly in accordance with an exemplary embodiment.

FIG. 7 is a perspective view of a portion of the wafer assembly in accordance with an exemplary embodiment.

FIG. 8 is a side view of a portion of the wafer assembly in accordance with an exemplary embodiment.

FIG. 9 is a cross sectional view of a portion of the wafer assembly showing the shield bridges providing shielding for the signal pairs in accordance with an exemplary embodiment.

FIG. 10 is a cross sectional view of a portion of the wafer assembly showing the shield bridges providing shielding for the signal pairs in accordance with an exemplary embodiment.

FIG. 11 is a side view of a portion of the wafer assembly showing the shield bridges providing shielding for the signal pairs in accordance with an exemplary embodiment.

### DETAILED DESCRIPTION OF THE INVENTION

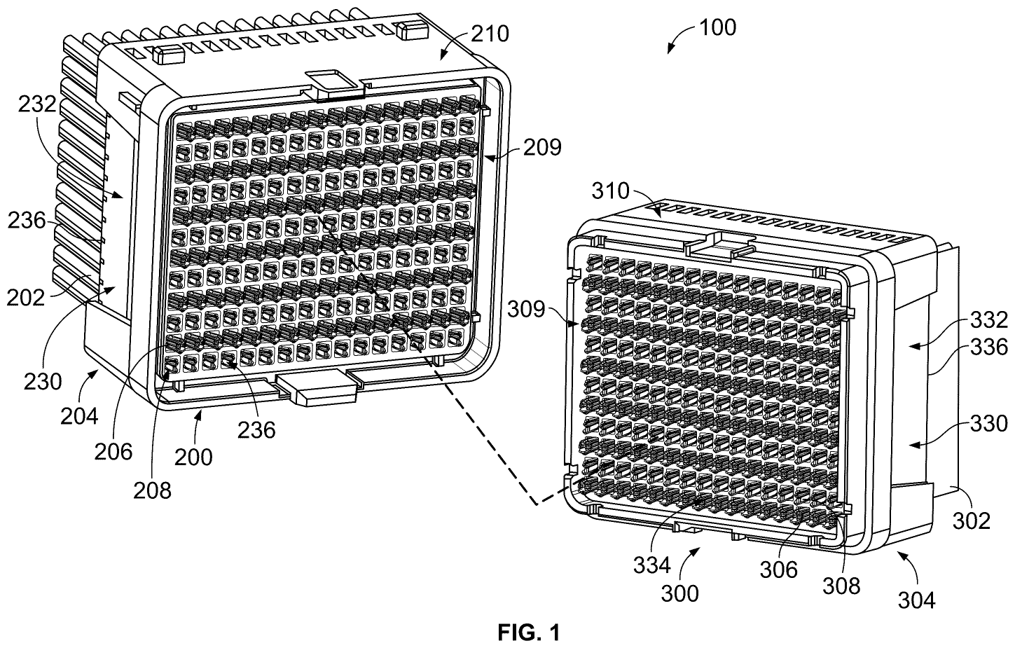

FIG. 1 illustrates a communication system 100 in accordance with an exemplary embodiment. The communication system 100 includes a first electrical connector assembly 200 and a second electrical connector assembly 300 configured to be electrically coupled together. In various embodiments, the communication system 100 may be a server or network switch. In other various embodiments, the communication system 100 may be a backplane system. In various embodiments, the first and second electrical connector assemblies 200, 300 are cable connector assemblies. However, in alternative embodiments, the first electrical connector assembly 200 and/or the second electrical connector assembly 300 may be a circuit board connector mounted to a circuit board.

In an exemplary embodiment, the first and second electrical connector assemblies 200, 300 are directly mated together. For example, the first electrical connector assembly 200 may be plugged into the second electrical connector assembly 300 and/or the second electrical connector assembly 300 may be plugged into the first electrical connector assembly 200. The first and second electrical connector assemblies 200, 300 are mated at a separable mating interface. The first and second electrical connector assemblies 200, 300 are directly mated together without the use of an adapter or additional electrical connector therebetween.

The first electrical connector assembly 200 includes first cables 202 terminated to a first electrical connector 204. The first electrical connector 204 includes first signal contacts 206 and first shield structures 208 providing electrical shielding for the first signal contacts 206.

The second electrical connector assembly 300 includes second cables 302 terminated to a second electrical connector 304. The second electrical connector 304 includes second signal contacts 306 and second shield structures 308 providing electrical shielding for the second signal contacts 306.

In an exemplary embodiment, the first and second electrical connectors 204, 304 have hermaphroditic mating interfaces defined, at least in part, by the signal contacts 206, 306 and the shield structures 208, 308. For example, the first and second electrical connectors 204, 304 may include both male mating portions and female mating portions that are co-nested during mating to electrically connect the first and second electrical connectors 204, 304. In various embodiments, the first and second electrical connectors 204, 304 may be identical to each other allowing use of the same parts in both the first and second electrical connectors 204, 304. However, in alternative embodiments, the first and second electrical connectors 204, 304 are not identical but rather have complementary mating interfaces. For example, the first electrical connector 204 may be a plug connector and the second electrical connector 304 may be a receptacle connector or header connector. The signal contacts 206 of the first electrical connector 204 may be pins and the signal contacts 306 of the second electrical connector 304 may be sockets.

In an exemplary embodiment, the signal contacts 206, 306 are arranged in rows and columns. The first signal contacts 206 are arranged for direct mating with the second signal contacts 306 when the first and second electrical connectors 204, 304 are mated. The shield structures 208, 308 provide electrical shielding around the signal contacts 206, 306 at the mating interfaces between the signal contacts 206, 306. In an exemplary embodiment, the first signal contacts 206 and the first shield structures 208 are pluggable into the second electrical connector 304. The second signal contacts 306 and the second shield structures 308 are pluggable into the first electrical connector 204. The communication system 100 is a direct plug communication system. The shield structures 208, 308 may provide circumferential shielding around the signal contacts 206, 306 at the mating interfaces. The shield structures 208, 308 may provide circumferential shielding along the signal paths between the first cables 202 and the second cables 302. Optionally, the shielding may be 360° shielding along the signal paths between the first cables 202 and the second cables 302 for improved signal integrity through the first and second electrical connectors 204, 304.

The signal contacts 206, 306 define electrical paths between the cables 202, 302. The signal contacts 206, 306 mate at a separable mating interface between the first and second electrical connectors 204, 304. For example, the mating interfaces of the signal contacts 206, 306 are arranged along mating planes (for example, parallel to the columns). In various embodiments, the first signal contacts 206 are arranged in pairs and the second signal contacts 306 are arranged in pairs. The shield structures 208, 308 cooperate to provide shielding for the corresponding signal contacts 206, 306 (for example, pairs of the signal contacts 206, 306). The shield structures 208, 308 may be electrically connected to cable shields of the cables 202, 302 to continue shielding along the signal paths between the cables 202, 302. The shield structures 208, 308 may be electrically connected to shielding structures passing through the electrical connectors 204, 304. The shield structures 208, 308 may provide shielding between the pairs of signal contacts 206, 306. The shield structures 208, 308 may be provided in the cable termination region where the conductors of the cables 202, 302 are terminated to the signal contacts 206, 306.

The first electrical connector 204 includes a housing 210 having a mating interface configured to be mated with the second electrical connector 304. The mating interface is provided at a front of the housing 210. In an exemplary embodiment, the first electrical connector 204 includes a plurality of wafers assemblies 230 coupled to the housing 210. The wafers assemblies 230 are received in a cavity 209 of the housing 210. The wafer assemblies 230 include the signal contacts 206 and the shield structures 208. The cables 202 are configured to be terminated to corresponding wafer assemblies 230. For example, the wafer assemblies 230 may support the cables 202 and signal conductors of the cables 202, which are soldered or otherwise terminated to corresponding signal contacts 206. The cables 202 may extend into the cavity 209. In an exemplary embodiment, the wafer assemblies 230 are oriented vertically. However, other orientations are possible in alternative embodiments. Each wafer assembly 230 includes a corresponding column of the signal contacts 206. The wafer assemblies 230 are stacked in the housing 210 to arrange the signal contacts 206 in rows.

In an exemplary embodiment, the wafer assemblies 230 are arranged in a wafer stack 232. For example, the wafer assemblies 230 are parallel to each other in the wafer stack 232. The wafer stack 232 extends from a rear of the housing 210. Optionally, the wafer assemblies 230 may be individually loaded into the housing 210, such as into the cavity 209 at a rear of the housing 210. Alternatively, the wafer assemblies 230 may be assembled together in the wafer stack 232, and the wafer stack 232 is then loaded into the rear of the housing 210 as a unit.

In an exemplary embodiment, each wafer assembly 230 extends between a mating end 234 and a terminating end 236. The cables 202 are terminated to the wafer assembly 230 at the terminating end 236. The mating end 234 extends into the housing 210 and is configured to be mated with the second electrical connector 304. In various embodiments, the wafer assembly 230 may be a right-angle wafer assembly having the mating end 234 at a right angle relative to the terminating end 236. The shield structures 208 are provided at the mating end 234 and are configured to be mated with the second electrical connector 304.

The second electrical connector 304 includes a housing 310 having a mating interface configured to be mated with the first electrical connector 204. The mating interface is provided at a front of the housing 310. In an exemplary embodiment, the second electrical connector 304 includes a plurality of wafer assemblies 330 coupled to the housing 310. The wafers assemblies 330 are received in a cavity 309 of the housing 310. The wafer assemblies 330 include the signal contacts 306 and the shield structures 308. The cables 302 are terminated to the corresponding wafer assemblies 330. For example, conductors of the cables 302 may be soldered or welded to the signal contacts 306. The cables 302 may extend into the cavity 309. In an exemplary embodiment, the wafer assemblies 330 are oriented vertically. However, other orientations are possible in alternative embodiments. Each wafer assembly 330 includes a corresponding column of the signal contacts 306. The wafer assemblies 330 are stacked in the housing 310 to arrange the signal contacts 306 in rows.

In an exemplary embodiment, the wafer assemblies 330 are arranged in a wafer stack 332. For example, the wafer assemblies 330 are parallel to each other in the wafer stack 332. The wafer stack 332 extends from a rear of the housing 310. Optionally, the wafer assemblies 330 may be individually loaded into the housing 310, such as into the cavity 309 at a rear of the housing 310. Alternatively, the wafer assemblies 330 may be assembled together in the wafer stack 332 and the wafer stack 332 is loaded into the rear of the housing 310.

In an exemplary embodiment, each wafer assembly 330 extends between a mating end 334 and a terminating end 336. The cables 302 are terminated to the wafer assembly 330 at the terminating end 336. The mating end 334 extends into the housing 310 and is configured to be mated with the first electrical connector 204. In various embodiments, the wafer assembly 330 may be a right-angle wafer assembly having the mating end 334 at a right angle relative to the terminating end 336. The shield structures 308 are provided at the mating end 334 and are configured to be mated with the first electrical connector 204.

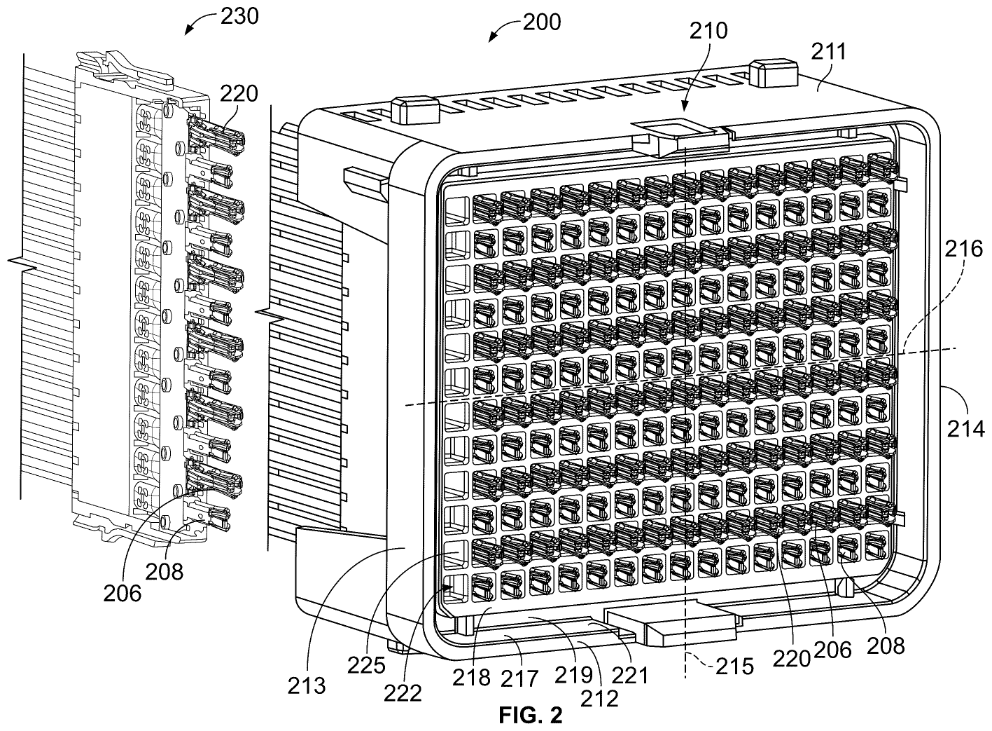

FIG. 2 is a front perspective, partially exploded view of the first electrical connector assembly 200 in accordance with an exemplary embodiment showing the mating interface. The second electrical connector assembly 300 (FIG. 1) may have an identical mating interface. One of the wafer assemblies 230 is shown poised for loading into the housing 210. The housing 210 holds the signal contacts 206 and the shield structures 208 for mating with the second electrical connector 304 (shown in FIG. 1). The housing 210 forms part of the mating interface with the second electrical connector 304.

The housing 210 has a top 211 and a bottom 212. The housing 210 has a first side 213 and a second side 214 opposite the first side 213. The housing 210 has a primary axis 215 extending from top the 211 to the bottom 212 and a secondary axis 216 extending from the first side 213 to the second side 214. The secondary axis 216 is perpendicular to the primary axis 215. In an exemplary embodiment, the signal contacts 206 and the shield structures 208 are arranged in columns parallel to the primary axis 215 and rows parallel to the secondary axis 216. The mating ends 234 are arranged along mating planes parallel to the primary axis 215 for interfacing with the second contacts 306 (FIG. 1). The wafer assemblies 230 are received in the housing 210 such that the wafer assemblies 230 are oriented parallel to the primary axis 215.

In an exemplary embodiment, the housing 210 is a multi-piece housing including a contact organizer 217 and a commoning member 218. The commoning member 218 is at the front of the housing 210. The contact organizer 217 may include locating features for locating the commoning member 218 relative to the contact organizer 217. In alternative embodiments, the housing 210 may be a single piece housing, such as being a molded part. The housing 210 may be plated plastic to provide shielding.

In an exemplary embodiment, the commoning member 218 faces the second electrical connector 304. The commoning member 218 is electrically conductive and is used to electrically common each of the shield structures 208. The commoning member 218 provides electrical shielding for the signal contacts 206 at the mating interface. The commoning member 218 may be electrically connected to the shield structures 308 (shown in FIG. 1) of the second electrical connector 304.

In an exemplary embodiment, the contact organizer 217 includes a base 219 and an outer shroud 221 surrounding the cavity 209. The base 219 may support towers 220 in the cavity 209. The towers 220 extend forward from the base 219. The towers 220 may be integral with the base 219, such as being co-molded with the base 219. In alternative embodiments, the towers 220 may be separate from the base 219 and loaded into the base 219. For example, the towers 220 may be part of the wafer assemblies 230. The towers 220 support the signal contacts 206 and the shield structures 208. In an exemplary embodiment, the towers 220 extend into openings 222 in the commoning member 218. The towers 220 may pass entirely through the openings 222 and extend forward of the front of the commoning member 218. The towers 220 are configured to be received in corresponding openings in a commoning member of the second electrical connector 304.

The wafer assemblies 230 are coupled to the housing 210 rearward of the base 219. The signal contacts 206 and the shield structures 208 pass through the base 219 to extend along the towers 220. The signal contacts 206 are electrically isolated from each other and from the shield structures 208 by the dielectric material of the towers 220.

The commoning member 218 is manufactured from a conductive material. For example, the commoning member 218 may be a metal block having the openings 222 formed therethrough. In alternative embodiments, the commoning member 218 may be manufactured from a conductive plastic. In other various embodiments, the commoning member 218 may be a plated plastic structure having plating at the front 224 and/or through the openings 222 and/or at the rear. The shield structures 208 are configured to be electrically connected to the commoning member 218. For example, the shield structures 208 may engage the commoning member 218 within the openings 222.

In an exemplary embodiment, the openings 222 pass entirely through the commoning member 218 and are defined by walls 225. In an exemplary embodiment, the openings 222 are rectangular. In the illustrated embodiment, the openings 222 are square shaped. However, the openings 222 may have other shapes. In an exemplary embodiment, the openings 222 are oversized relative to the towers 220. For example, each opening 222 may be sized to receive two of the towers 220 (one from the first electrical connector 204 and one from the second electrical connector 304).

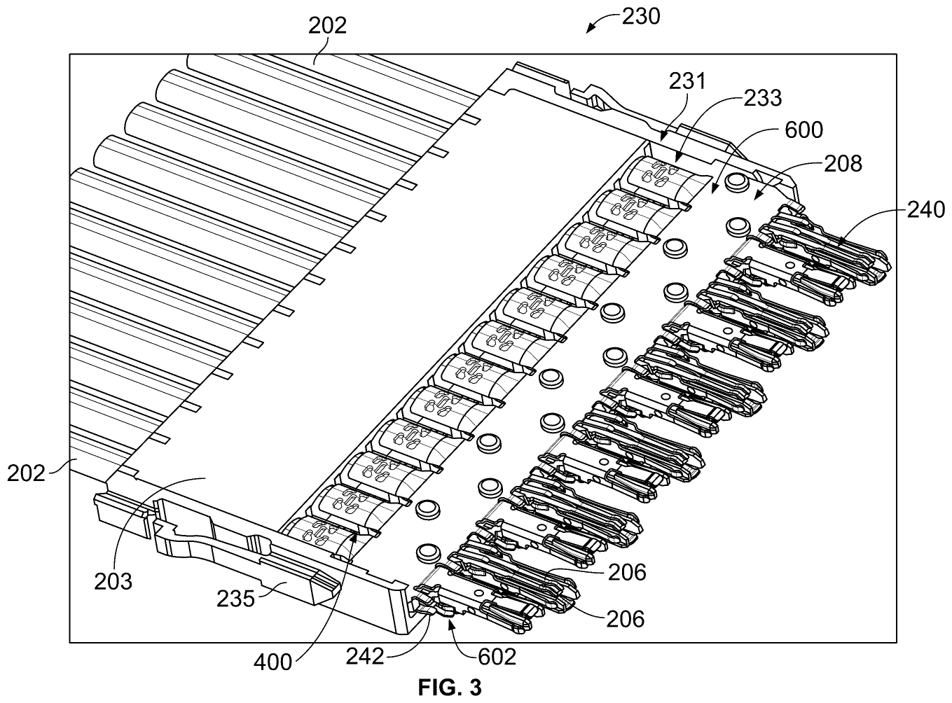

FIG. 3 is a perspective view of the wafer assembly 230 in accordance with an exemplary embodiment. In an exemplary embodiment, the wafer assembly 230 is identical to the wafer assembly 330 (shown in FIG. 1) with both wafer assemblies 230, 330 including identical components. However, the wafer assemblies 230, 330 may be different in other embodiments, such as including different types of contacts (for example, pins or sockets).

In an exemplary embodiment, a plurality of cable assemblies 228 are terminated to the wafer assembly 230. Each cable assembly 228 includes one of the cables 202 and one or more shield bridges 400 coupled to the corresponding cable 202. The shield bridges 400 provide electrical shielding at the ends of the cables 202. Each shield bridge 400 is configured to be electrically connected to the shield structure 208 of the wafer assembly 230 to electrically connect the cable 202 to the shield structure 208. The shield bridges 400 provides shielding in the cable termination region, such as between the cables 202, which improves signal integrity at the transition area between the cables 202 and the wafer assembly 230.

The wafer assembly 230 includes the signal contacts 206 and the shield structures 208. The signal contacts 206 and the shield structures 208 are connected to the cables 202. In an exemplary embodiment, the wafer assembly 230 includes a leadframe 240 including the signal contacts 206. The wafer assembly 230 includes a dielectric wafer body 242 holding the leadframe 240. The wafer assembly 230 includes a first ground frame 600 coupled to a first side of the wafer body 242 and a second ground frame 602 coupled to a second side of the wafer body 242. However, the wafer assembly 230 may be provided with a single ground frame (for example, the first ground frame 600 or the second ground frame 602) in alternative embodiments. The first and second ground frames 600, 602 form portions of the shield structures 208. The first and second ground frames 600, 602 provide electrical shielding for the leadframe 240. The shield bridges 400 are electrically connected to the first and second ground frames 600, 602 to electrically connect the cables 202 to the first and second ground frames 600, 602.

In an exemplary embodiment, the wafer assembly 230 includes a wafer frame 231 having a cavity 233. The wafer body 242 and the cables 202 are received in the cavity 233. The wafer frame 231 is used to secure the wafer assembly 230 in the housing 210 (shown in FIG. 2). The wafer frame 231 includes latches 235 to latchably secure the wafer frame 231 in the housing 210. In alternative embodiments, the wafer body 242 may be integral with the wafer frame 231, such as being co-molded.

In an exemplary embodiment, the wafer assembly 230 includes a cable holder 203 holding the cables 202. The cable holder 203 is received in the cavity 233. In various embodiments, the cable holder 203 is an overmolded body that is overmolded over the cables 202. The cable holder 203 may be overmolded over at least portions of the shield bridges 400. The cable holder 203 may be formed in place on the cables 202. The cable holder 203 may be formed in place in the cavity 233.

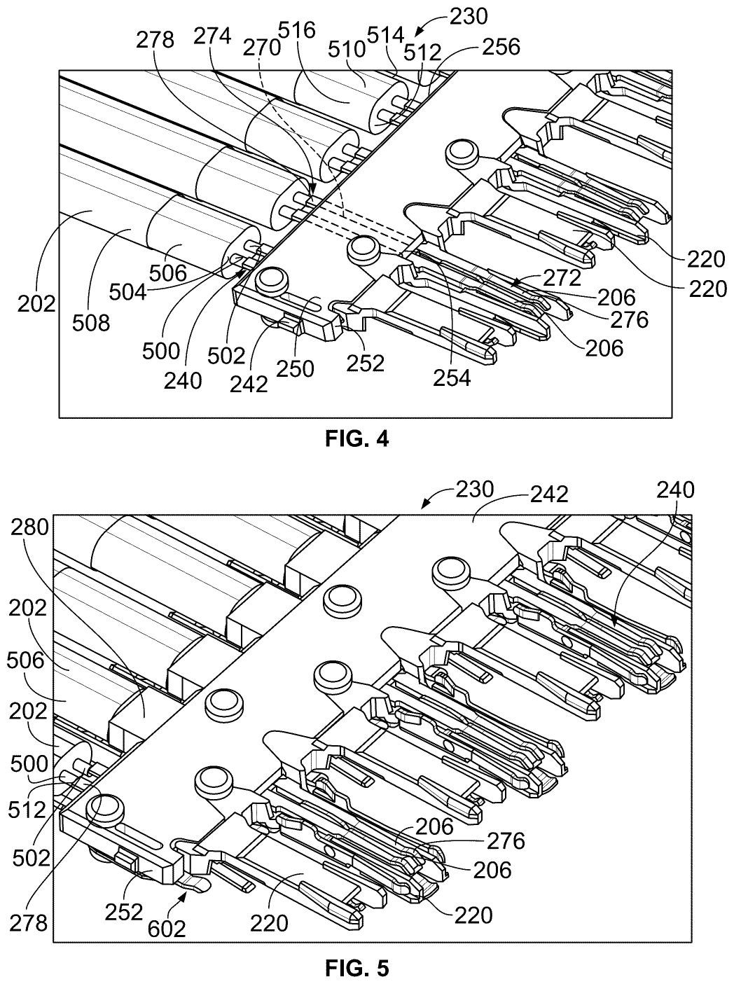

FIG. 4 is a perspective view of a portion of the wafer assembly 230 in accordance with an exemplary embodiment, such as during an initial state of assembly. FIG. 4 shows the cables 202, the leadframe 240, the dielectric wafer body 242, and the towers 220. The cables 202 are shown terminated to the signal contacts 206 of the leadframe 240. The wafer body 242 supports the signal contacts 206 of the leadframe 240. The towers 220 extend from the wafer body 242 to support ends of the signal contacts 206.

The cables 202 are shielded cables. In an exemplary embodiment, each cable 202 is a twin-axial cable having a pair of signal conductors, namely a first signal conductor 500 and a second signal conductor 502. The signal conductors 500, 502 are arranged as a signal pair. The signal conductors 500, 502 are held by an insulator(s) 504. A cable shield 506 surrounds the insulator 504. The cable shield 506 provides shielding for the signal pair of signal conductors 500, 502 along the length of the cable 202. A cable jacket 508 surrounds the cable shield 506. The end of the cable 202 is stripped for termination to the signal contacts 206 in a cable termination region in the space between the end of the cable (end of the insulator 504) and the leadframe (end of the wafer body 242).

In an exemplary embodiment, the cable 202 is oval shaped or obround to surround the signal pair of signal conductors 500, 502. In various embodiments, the cable shield 506 includes a first side 510 and a second side 512 opposite the first side 510. The cable shield 506 includes a first or upper end 514 and a second or lower end 516 opposite the first end 514. Optionally, the sides 510, 512 may be generally flat or planar. The ends 514, 516 are curved between the sides 510, 512. The cable 202 may have other shapes in alternative embodiments, such as having the sides 510, 512 curved, such as at a radius of curvature that is different from the radius of curvature of the ends 514, 516.

The leadframe 240 is a stamped and formed leadframe that forms the signal contacts 206 from a metal sheet. In an exemplary embodiment, the leadframe 240 only includes the signal contacts 206. However, in alternative embodiments, the leadframe 240 may include ground contacts arranged between corresponding signal contacts to provide electrical shielding for the signal contacts. In an exemplary embodiment, the signal contacts 206 are arranged in pairs configured to carry differential signals. However, the signal contacts 206 may be single ended signal contacts in alternative embodiments.

The wafer body 242 surrounds the signal contacts 206 and positions the signal contacts 206 relative to each other. In an exemplary embodiment, the wafer body 242 is manufactured from a dielectric material, such as a plastic material. In an exemplary embodiment, the wafer body 242 is an overmold that is overmolded around the leadframe 240. The wafer body 242 includes first and second sides 250, 252. The wafer body 242 includes a front 254 and a rear 256 extending between a top and a bottom. The front 254 defines a mating end. The signal contacts 206 extend from the wafer body 242 at the front 254 for connection to the second electrical connector 304 (shown in FIG. 1). In an exemplary embodiment, the towers 220 extend from the front 254 of the wafer body 242 to support the ends of the signal contacts 206. In the illustrated embodiment, the towers 220 are separate and discrete from the wafer body 242 and coupled thereto. In alternative embodiments, the towers 220 are integral with the wafer body 242, such as being co-molded with the wafer body 242. The rear 256 defines a cable end. The cables 202 extend from the rear 256 along cable axes.

Each signal contact 206 includes a contact body 270 extending between a mating end 272 and a terminating end 274. The contact body 270 extends along a contact axis. Optionally, the contact axis is parallel to the corresponding cable axis. In an exemplary embodiment, the contact body 270 is stamped and formed as part of the leadframe 240. The contact bodies 270 of the leadframe 240 are generally arranged in a leadframe plane parallel to the sides 250, 252 of the wafer body 242. The signal contact 206 includes a spring beam 276 at the mating end 272. The spring beam 276 is deflectable and configured to be mated with a corresponding spring beam of the second signal contact 306 (shown in FIG. 1). In various embodiments, the spring beam 276 is generally aligned with the main portion of the contact body 270. The mating end may include other types of contacts, such as pins, sockets, tuning fork contacts, and the like. In an exemplary embodiment, the signal contact 206 includes a solder pad 278 at the terminating end 274 for soldering or welding to the corresponding signal conductor 500, 502 of the cable 202.

FIG. 5 is a perspective view of a portion of the wafer assembly 230 in accordance with an exemplary embodiment during another stage of assembly. FIG. 5 shows the cables 202, the leadframe 240, the dielectric wafer body 242, the towers 220, conductor supports 280, and the second ground frame 602. After the conductors 500, 502 of the cables 202 are terminated to the solder pads 278 of the signal contacts 206, the conductor supports 280 are added to support the termination in the termination region. The conductor supports 280 are non-conductive. For example, the conductor supports 280 are manufactured from a dielectric material. The conductor supports 280 provide strain relief for the conductors 500, 502. In various embodiments, the conductor supports 280 are molded in place over the conductors 500, 502 and the solder pads 278. The conductor supports 280 may be acrylic or epoxy blocks connected to the solder pads 278 and the signal conductors 500, 502. The shield bridges 400 (shown in FIG. 3) are configured to surround or engage the conductor supports to provide shielding along the signal paths, such as along the termination between the signal conductors 500, 502 and the solder pads 278. The shield bridges 400 may be formed in place against the conductor supports 280, such as being formed in place between the conductor supports 280.

In an exemplary embodiment, the second ground frame 602 is attached to the second side 252 of the wafer body 242. The second ground frame 602 extends along the towers 220 to provide shielding for the spring beams 276 of the signal contacts 206. The shield bridges 400 are configured to be electrically connected to the second ground frame 602.

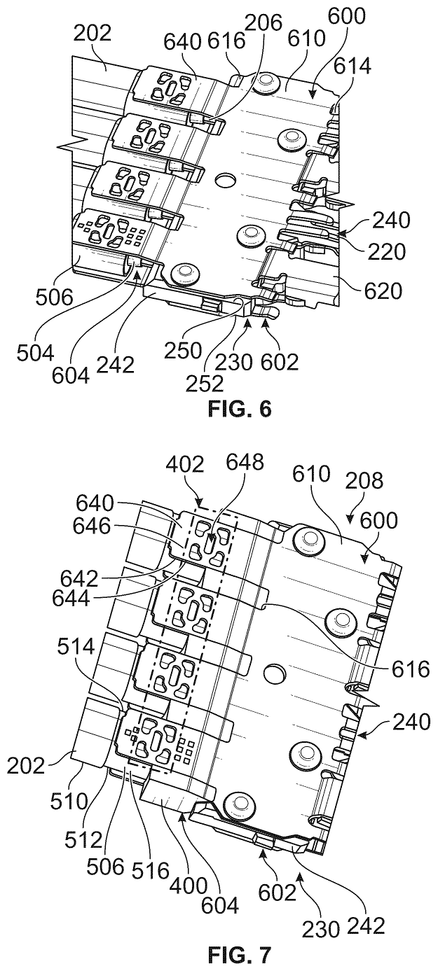

FIG. 6 is a perspective view of a portion of the wafer assembly 230 in accordance with an exemplary embodiment. FIG. 6 shows the cables 202, the leadframe 240, the dielectric wafer body 242, the towers 220, the first ground frame 600 and the second ground frame 602. The conductor supports 280 (FIG. 5) are removed to illustrate a cable termination region 604 without the conductor supports 280, such as to show the signal conductors 502, 504 and the mating ends of the signal contacts 206.

The first and second ground frames 600, 602 are attached to the wafer body 242. The first ground frame 600 is attached to the first side 250 of the wafer body 242 and the second ground frame 602 is attached to the second side 252 of the wafer body 242. The first and second ground frames 600, 602 provide shielding for the signal contacts 206. In an exemplary embodiment, the first and second ground frames 600, 602 are configured to be electrically connected to each of the cable shields 506. The ground frames 600, 602 may be similar to each other, such as including similar components. The first ground frame 600 is described in more detail below; however, the second ground frame 602 may include like components identified with like reference numerals.

In an exemplary embodiment, the ground frame 600 includes a ground plate 610, ground shields 620 extending from the ground plate 610 for shielding the mating ends of the signal contacts 206, and termination tabs 640 extending from the ground plate 610 for connection to the cable shields 506. The termination tabs 640 may extend along portions of the cable termination region 604, such as along the top and/or sides and/or bottom of the termination region 604. In the illustrated embodiment, the shield portion of the ground shield 620 is C-shaped. The shield portion may have other shapes in alternative embodiments. The ground plate 610 forms a main body of the ground frame 600. The ground plate 610 may be planar. The ground plate 610 is attached to the wafer body 242, such as to the first side 250 of the wafer body 242. The ground plate 610 may be heat stacked to the wafer body 242. The ground plate 610 extends between a front edge 614 and a rear edge 616. The ground shields 620 extend from the front edge 614 of the ground plate 610 and the termination tabs 640 extend from the rear edge 616 of the ground plate 610.

Each termination tab 640 extends rearward from the ground plate 610 to couple to the cable shields 506. In an exemplary embodiment, the termination tabs 640 may extend along the sides of the cable shields 506 and may be soldered or welded to the cable shields 506 to create a direct electrical connection between the ground frame 600 and the cable shields 506. The cable shields 506 may be located in the pocket or space defined between the termination tabs 640 of the ground frames 600, 602. The termination tabs 640 provide shielding along the cable termination region 604.

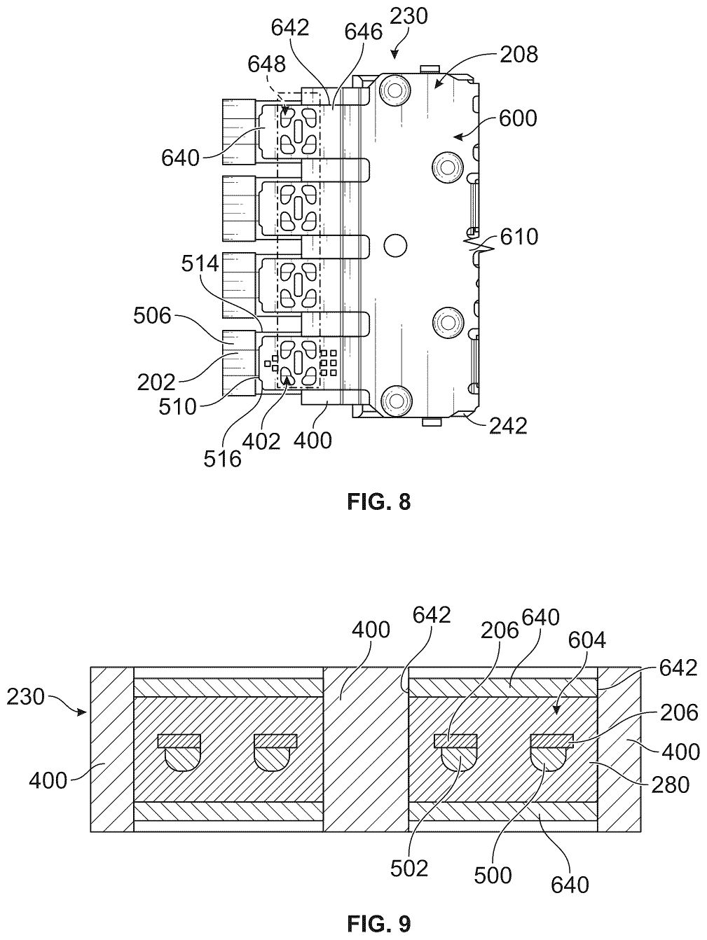

FIG. 7 is a perspective view of a portion of the wafer assembly 230 in accordance with an exemplary embodiment. FIG. 8 is a side view of a portion of the wafer assembly 230 in accordance with an exemplary embodiment. FIGS. 7 and 8 show the cables 202, the leadframe 240, the dielectric wafer body 242, the first ground frame 600, the second ground frame 602 and shield bridges 400. The shield bridges 400 extend across the space between the cable shields 506 and the ground frames 600, 602 to provide shielding for the signal pairs. For example, the shield bridges 400 provide shielding between the signal pairs. The shield bridges 400 are electrically connected to the cable shields 506 and the ground frames 600, 602.

In an exemplary embodiment, the shield bridges 400 are formed in place in the cable termination region 604 to electrically connect the ground frames 600, 602 and the cable shields 506. The shield bridges 400 fill spaces between the cable shields 506. The shield bridges 400 fill the space between the conductor supports 280 (FIG. 5). In an exemplary embodiment, the shield bridge 400 is manufactured from an electrically conductive material, such as a conductive resin. The electrically conductive resin may be made up of synthetic resin and a conductive filler. Silver, nickel, carbon, and the like may be used as the conductive fillers and epoxy resin, urethane resin, silicone resin, synthetic rubber, and the like may be used as binders. The shield bridges 400 may be manufactured from a conductive acrylic material in various embodiments. In alternative embodiments, the shield bridges 400 are manufactured from a conductive hot melt material or a conductive room temperature vulcanization (RTV) silicone material.

In an exemplary embodiment, the shield bridges 400 form a direct electrical path between the cable shields 506 and the ground frames 600, 602. The shield bridges 400 may directly engage the termination tabs 640, such as along the edges 642, interior surfaces 644 and/or exterior surfaces 646 of the termination tabs 640. The shield bridges 400 may at least partially fill in openings 648 of the termination tabs 640 to electrically connect the termination tabs 640 to the cable shields 506. The shield bridges 400 may directly engage the ground plates 610 of the ground frames 600, 602, such as at the rear edge 616.

In an exemplary embodiment, the shield bridges 400 are molded in place in the wafer assembly 230. For example, the shield bridges 400 may be molded to the cable shields 506 and/or the conductor supports 280 and/or the ground frames 600, 602. The shield bridges 400 may be molded to the wafer body 242. In an exemplary embodiment, the cable shields 506 may be pretreated, such as with a chemical treatment, to remove oxides from the cable shields 506 prior to connecting the shield bridges 400 to the cable shields 506. The shield bridges 400 may completely surrounds the cable shield 506, such as on all four sides of the cable 202, with direct physical contact with the cable shield 506. The shield bridges 400 may have curved profiles following curvature of the cable shields 506. In an exemplary embodiment, connecting portions 402 are provided between the shield bridges 400. The connecting portions 402 are integral with each of the shield bridges 400 to electrically common each of the shield bridges 400. The connecting portions 402 are manufactured form the same material as the shield bridges 400. The connecting portions 402 extend along the sides 510, 512. The shield bridges 400 extend along the ends 514, 516.

The shield bridges 400 and the termination tabs 640 form a shield pocket around the cable termination region 604. The shield bridges 400 continue the generally circumferential shielding provided by the cable shield 506 forward of the stripped end of the cable 202, such as along the stripped portions of the signal conductors (for example, the termination portions of the signal conductors) to provide shielding around the termination zone. The shield bridges 400 provide shielding along both sides, as well as the top and the bottom of the signal conductors. The shield bridges 400 provide shielding between the cables 202 (for example, above and below the cables). The shield bridges 400 provide shielding along the conductor supports 280. The shield bridges 400 form part of the shield structure 208 of the wafer assembly 230 to provide efficient shielding around the signal paths as the signals transition between the cable 202 and the signal contacts 206. The shield bridges 400 provide shielding not only along the two sides, but also along the top and the bottom (for example, between the cables) to improve the shielding and improve signal integrity of the system.

FIG. 9 is a cross sectional view of a portion of the wafer assembly 230 showing the shield bridges 400 providing shielding for the signal pairs. FIG. 9 shows the conductor supports 280 surrounding the signal pairs. For example, each conductor support 280 surrounds the signal conductor 500, 502 and the mating ends of the signal contacts 206 in the cable termination region 604. The shield bridges 400 are located between the conductor supports 280. The shield bridges 400 are electrically connected to the termination tabs 640, such as along the edges 642.

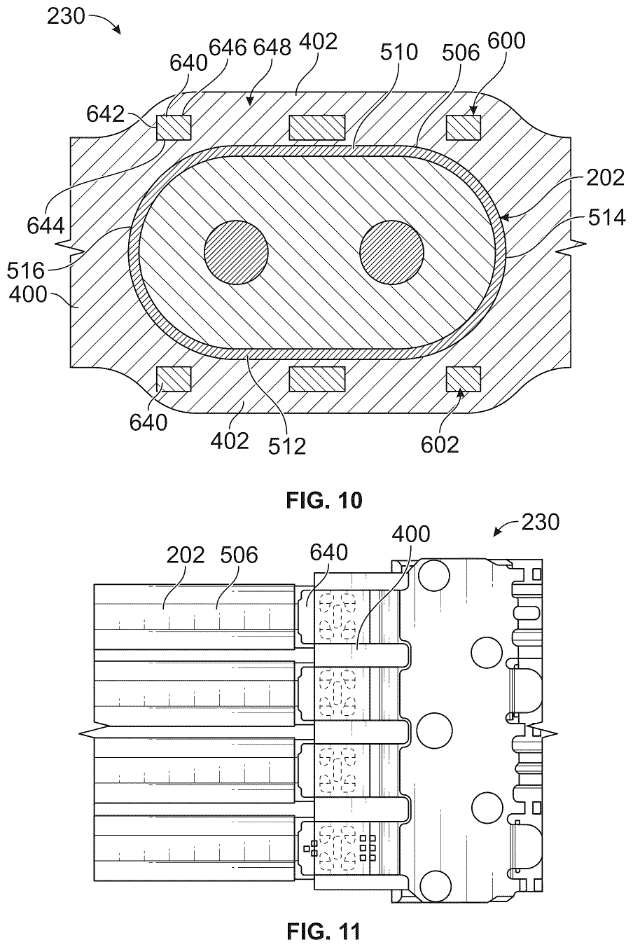

FIG. 10 is a cross sectional view of a portion of the wafer assembly 230 showing the shield bridges 400 providing shielding for the signal pairs. FIG. 10 shows the termination tabs 640 along the sides 510, 512 of the cable 202. The shield bridges 400 may surround the cable shield 506, such as to fill the spaces between the cables 202. The shield bridges 400 form a direct electrical connection to the cable shield 506. The shield bridges 400 form a direct electrical connection to the termination tabs 640 of the ground frames 600, 602, such as along the edges 642, the interior surfaces 644 and/or the exterior surfaces 646. The shield bridges 400 at least partially fill in the openings 648 of the termination tabs 640 to electrically connect the termination tabs 640 to the cable shield 506. For example, the connecting portions 402 may fill the openings 648. The shield bridges 400 at least partially fill in the spaces between the termination tabs 640 and the cable shield 506 (for example, at the corners between the sides 510, 512 and the ends 514, 516). The shield bridges 400 may completely surrounds the cable shield 506, such as on all four sides of the cable 202, with direct physical contact with the cable shield 506. The shield bridges 400 may have curved profiles following curvature of the cable shields 506.

FIG. 11 is a side view of a portion of the wafer assembly 230 showing the shield bridges 400 providing shielding for the signal pairs. The shield bridges 400 fill the spaces between the cables 202. The shield bridges 400 form direct electrical connections to the cable shields 506. The shield bridges 400 form direct electrical connections to the termination tabs 640.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A wafer assembly for an electrical connector, the wafer assembly comprising:
a leadframe having signal contacts extending between mating ends and terminating ends, the signal contacts having main bodies between the mating ends and the terminating ends;
cables rearward of the leadframe, each cable including first and second signal conductors arranged as a signal pair, the first and second signal conductors being terminated to the terminating ends of the corresponding signal contacts at a cable termination region of the wafer assembly, each cable includes a cable shield surrounding the conductors to provide shielding for the signal pair and being separated from the conductors by a dielectric insulator;
a wafer body holding the main bodies of the signal contacts, wherein the mating ends of the signal contacts extend forward of the wafer body and the terminating ends of the signal contacts extend rearward of the wafer body;
a ground frame attached to the wafer body to provide electrical shielding for the leadframe; and
shield bridges extending across the space between the cable shields and the ground frame to provide shielding for the signal pairs and the terminating ends of the corresponding signal contacts, the shield bridges being formed in place in the cable termination region to electrically connect the ground frame and the cable shields.

2. The wafer assembly of claim 1, wherein the shield bridges provide shielding between the signal pairs.

3. The wafer assembly of claim 1, wherein the shield bridges fill spaces between the cable shields.

4. The wafer assembly of claim 1, further comprising nonconductive conductor supports surrounding the corresponding signal conductors and signal contacts in the cable termination region, the shield bridges extending between the nonconductive conductor supports.

5. The wafer assembly of claim 1, wherein the shield bridges are one of a conductive acrylic, a conductive hot melt, or a conductive room temperature vulcanization silicone.

6. The wafer assembly of claim 1, wherein the shield bridges form a direct electrical path between the cable shields and the ground frame.

7. The wafer assembly of claim 1, wherein the ground frame includes a ground plate extending along the wafer body and termination tabs extending from the ground plate, the termination tabs being coupled to the cable shields of the corresponding cables, the shield bridges engaging the termination tabs and the ground plate to electrically connect to the ground frame.

8. The wafer assembly of claim 7, wherein the ground plate includes a rear edge, the termination tabs extending rearward from the rear edge, the shield bridges engaging the rear edge to electrically connect to the ground frame.

9. The wafer assembly of claim 7, wherein the shield bridges at least partially fill spaces between the termination tabs and the cable shields.

10. The wafer assembly of claim 7, wherein the termination tabs include openings aligned with the cable shields, the shield bridges fill in the openings to electrically connect the termination tabs and the cable shields.

11. The wafer assembly of claim 1, wherein each shield bridge completely surrounds the cable shield of the corresponding cable on all four sides of the cable with direct physical contact with the cable shield.

12. The wafer assembly of claim 1, wherein each shield bridge has a curved profile following a curvature of the corresponding cable shield.

13. The wafer assembly of claim 1, wherein the ground frame is electrically connected to all of the shield bridges to electrically common each of the shield bridges and the cable shields.

14. The wafer assembly of claim 1, further comprising connecting portions integral with each of the shield bridges to electrically common each of the shield bridges, the connecting portions being manufactured from the same material as the shield bridges.

15. A wafer assembly for an electrical connector, the wafer assembly comprising:
a leadframe having signal contacts extending between mating ends and terminating ends, the signal contacts having main bodies between the mating ends and the terminating ends;
cables rearward of the leadframe, each cable including first and second signal conductors arranged as a signal pair, the first and second signal conductors being terminated to the terminating ends of the corresponding signal contacts at a cable termination region of the wafer assembly, each cable includes a cable shield surrounding the conductors to provide shielding for the signal pair and being separated from the conductors by a dielectric insulator;
a wafer body holding the main bodies of the signal contacts, the wafer body having a front, a rear, a first side between the front and the rear, and a second side between the front and the rear, the cables located rearward of the rear of the wafer body, wherein the wafer body supports the main bodies of the signal contacts, the mating ends extending forward of the front of the wafer body, the terminating ends extending rearward of the rear of the wafer body;
a first ground frame attached to the first side of the wafer body to provide electrical shielding for the leadframe, the first ground frame including first ground shields providing shielding for the mating ends of the corresponding signal contacts, the first ground frame being spaced apart from the cable shields;
a second ground frame attached to the second side of the wafer body to provide electrical shielding for the leadframe, the second ground frame being spaced apart from the cable shields; and
shield bridges extending across the space between the cable shields and the first and second ground frames to provide shielding for the signal pairs and the terminating ends of the corresponding signal contacts, the shield bridges being formed in place in the cable termination region, the shield bridges conforming to and surrounding the cable shields at the ends of the corresponding cables, the shield bridges being electrically connected to the first and second ground frames to electrically connect the first and second ground frames and the cable shields.

16. The wafer assembly of claim 15, wherein the shield bridges provide shielding between the signal pairs.

17. The wafer assembly of claim 15, wherein the shield bridges fill spaces between the cable shields.

18. The wafer assembly of claim 15, further comprising nonconductive conductor supports aligned with the wafer body between the first and second ground frames, the nonconductive conductor supports surround the corresponding signal conductors and signal contacts in the cable termination region, the shield bridges extending between the nonconductive conductor supports.

19. An electrical connector assembly comprising:
a housing having a mating interface configured to be mated with a mating electrical connector assembly, the housing having a cavity; and
wafer assemblies received in the cavity and coupled to the housing, the wafer assemblies arranged in a wafer stack, each wafer assembly including a leadframe, a wafer body holding the leadframe, cables coupled to the leadframe at a cable termination region, a ground frame coupled to the wafer body to provide electrical shielding for the leadframe, and shield bridges extending across the space between the cable shields and the ground frame to provide shielding in the cable termination region, the shield bridges being formed in place in the cable termination region to electrically connect the ground frame and the cable shields.

20. The electrical connector assembly of claim 19, wherein the shield bridges provide shielding between contacts of the leadframe.
